(19) United States
(12) Patent Application Publication
(10) Pub. No.: US 2015/0108689 A1
(43) Pub. Date: Apr. 23, 2015

(54) PLASTIC MOLDING APPARATUS WITH AN ADJUSTABLE BARREL AND ASSOCIATED METHODS

(71) Applicant: D AND D MANUFACTURING, Merritt Island, FL (US)

(72) Inventors: Dale Polk, JR., Merritt Island, FL (US); Timothy A. Polk, Titusville, FL (US)

(21) Appl. No.: 14/519,652

(22) Filed: Oct. 21, 2014

Related U.S. Application Data
(60) Provisional application No. 61/894,099, filed on Oct. 22, 2013.

(51) Int. Cl. B29B 13/00

(52) U.S. Cl. CPC B29B 13/00; B29K 2101/10
USPC 264/319; 425/112

(57) ABSTRACT

A molding apparatus includes an extruder to provide a molten composite material, and an adjustable extension barrel coupled to the extruder to receive the molten composite material. The adjustable extension barrel has a drop point to output the molten composite material. The adjustable extension barrel is moveable in a first direction between an extended position and a retracted position to change position of the drop point. A structure is movable in a second direction that is perpendicular to the first direction. A lower mold is carried by the structure and is positioned to receive the molten composite material from the drop point of the adjustable extension barrel. A press includes an upper mold and is operated to press the upper mold against the lower mold to form a molded article.

### RELATED APPLICATION

This application claims the benefit of U.S. Provisional Application Ser. No. 61/894,099 filed Oct. 22, 2013, the entire contents of which are incorporated herein by reference.

### FIELD OF THE INVENTION

The present invention relates to the field of plastic molding, and, more particularly, to an extrusion-molding apparatus and related methods.

### BACKGROUND OF THE INVENTION

Composites are materials formed from a mixture of two or more components that produce a material with properties or characteristics that are superior to those of the individual materials. Most composites comprise two parts, a matrix component and one or more reinforcement components.

Matrix components are the materials that bind the composite together and they are usually less stiff than the reinforcement components. These materials are shaped under pressure at elevated temperatures. The matrix encapsulates the reinforcements in place and distributes the load among the reinforcements. Since reinforcements are usually stiffer than the matrix material, they are the primary load-carrying component within the composite. Reinforcements may come in many different forms ranging from fibers, to fabrics, to particles or rods imbedded into the matrix that form the composite.

There are many different types of composites, including plastic composites. Each plastic resin has its own unique properties, which when combined with different reinforcements create composites with different mechanical and physical properties. Plastic composites are classified within two primary categories: thermoset and thermoplastic composites.

Thermoset composites use thermoset resins as the matrix material. After application of heat and pressure, thermoset resins undergo a chemical change, which cross-links the molecular structure of the material. Once cured, a thermoset part cannot be remolded. Thermoset plastics resist higher temperatures and provide greater dimensional stability than most thermoplastics because of the tightly cross-linked structure found in thermoset plastic. Thermoplastic matrix components are not as constrained as thermoset materials and can be recycled and reshaped to create a new part.

Common matrix components for thermoplastic composites include polypropylene (PP), polyethylene (PE), polyetheretherketone (PEEK) and nylon. Thermoplastics that are reinforced with high-strength, high-modulus fibers to form thermoplastic composites provide dramatic increases in strength and stiffness, as well as toughness and dimensional stability.

Compression molding and injection molding are not readily capable of producing a thermoplastic composite reinforced with long fibers (i.e., greater than about 12 millimeters) that remain largely unbroken during the molding process itself. This is especially true for the production of large and more complex parts.

A three-step process may be utilized to mold such a part or article: (1) third party compounding of a pre-preg composite formulation, (2) preheating of pre-preg material in an oven, and (3) insertion of molten material in a mold to form a desired part. This process has several disadvantages that limit the industry's versatility for producing more complex, large parts with sufficient structural reinforcement. One disadvantage is that the sheet-molding process cannot readily produce a part of varying thickness, or parts requiring a deep draw of thermoplastic composite material. The thicker the extruded sheet, the more difficult it is to re-melt the sheet uniformly through its thickness to avoid problems associated with the structural formation of the final part.

One approach to varying the thickness of an extruded material is disclosed in U.S. published patent application no. 2013/0193611 to Polk, which is incorporated herein by reference in its entirety. Polk discloses an apparatus that utilizes a dual trolley mold transport system to vary the thickness of the extruded material. The mold transport assembly rides on a first movable structure in the x direction (first trolley) and on a second movable structure in the y direction (second trolley). The combination of being able to control both x and y direction movement by use of one trolley riding on the other gives control of the x-y plane. While effective in varying the thickness of an extruded material, there is still a need to improve upon this process.

### SUMMARY OF THE INVENTION

In view of the foregoing background, it is therefore an object of the present invention to improve upon the extrusion molding process for forming molded articles.

This and other objects, advantages and features in accordance with the present invention are provided by a molding apparatus comprising an extruder configured to provide a molten composite material, and an adjustable extension barrel coupled to the extruder to receive the molten composite material.

The adjustable extension barrel may have a drop point to output the molten composite material, with the adjustable extension barrel being moveable in a first direction between an extended position and a retracted position so as to change position of the drop point.

A structure may be movable in a second direction that is perpendicular to the first direction. A lower mold may be carried by the structure and may be positioned to receive the molten composite material from the drop point of the adjustable extension barrel. A press includes an upper mold and may be configured to press the upper mold against the lower mold to form a molded article.

Movement of the adjustable extension barrel in the second direction simplifies deposition of the molten composite material in the lower mold. Without movement of the adjustable extension barrel in the second direction, a second movable structure would be needed to move the lower mold.

The extruder may comprise an auger that pushes the molten composite material toward the drop point of the adjustable extension barrel. When the adjustable extension barrel is in the retracted position, the drop point may be adjacent the auger.

When the adjustable extension barrel is in the fully retracted position, there may be no gap between the auger and the drop point. An advantage of the adjustable extension barrel in the fully retracted position is that molten composite material may not remain in the barrel since there is no gap between the auger and the drop point. For color changes in the molten composite material, this avoids an overlap of parts with different colors then as initially intended.

The molten composite material may be gravity deposited from the drop point of the adjustable extension barrel to the lower mold. The molding apparatus may further comprise a controller for controlling a volumetric flow of the molten composite material from the drop point of the adjustable extension barrel.

The molding apparatus may further comprise a pair of spaced apart rails, and wherein the structure may comprise a trolley that rides on the pair of spaced apart rails.

The molten composite material may comprise a matrix component and at least one reinforcement component. The molten composite material may comprise a molten plastic composite. The molten plastic composite may comprise a thermoset composite or a thermoplastic composite.

Another aspect is directed to a method of using a molding apparatus as described above to form a molded article.

### BRIEF DESCRIPTION OF THE DRAWINGS

FIG. 1 is an overview of a plastic molding apparatus with an extruder having an adjustable barrel in accordance with the present invention.

FIG. 2 is side perspective view of the extruder with the adjustable barrel shown in FIG. 1.

FIG. 3 is top view of the extruder shown in FIG. 1 with the adjustable barrel in an extended position.

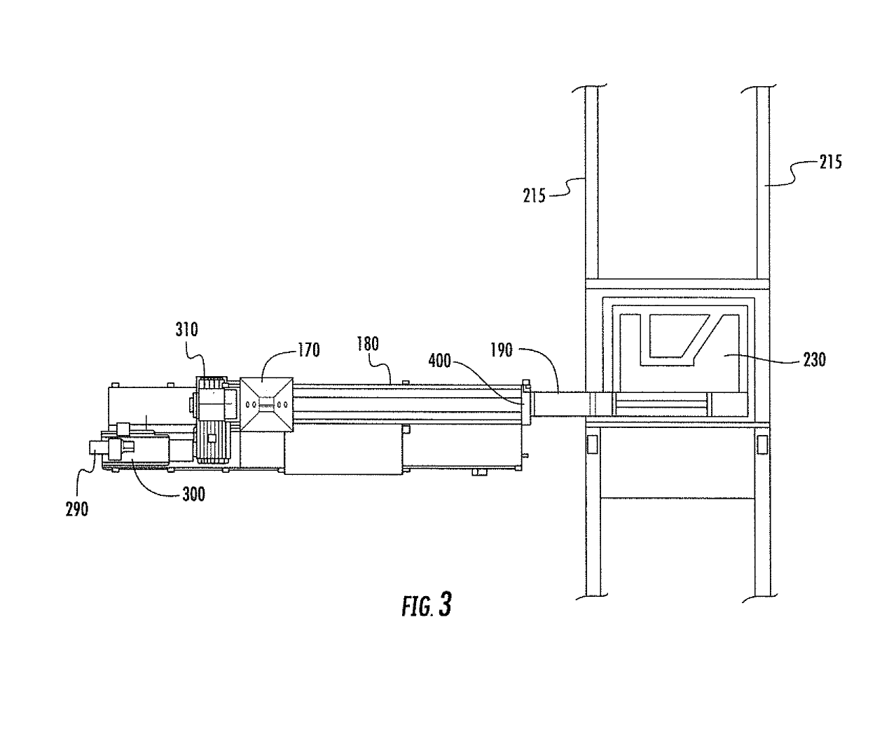

FIG. 4 is a cross-sectional view of the adjustable barrel shown in FIG. 3.

FIG. 5 is top view of the extruder shown in FIG. 1 with the adjustable barrel in a retracted position.

FIG. 6 is a cross-sectional view of the adjustable barrel shown in FIG. 5.

FIG. 7 is a flowchart illustrating a method for using a molding apparatus to form a molded article in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

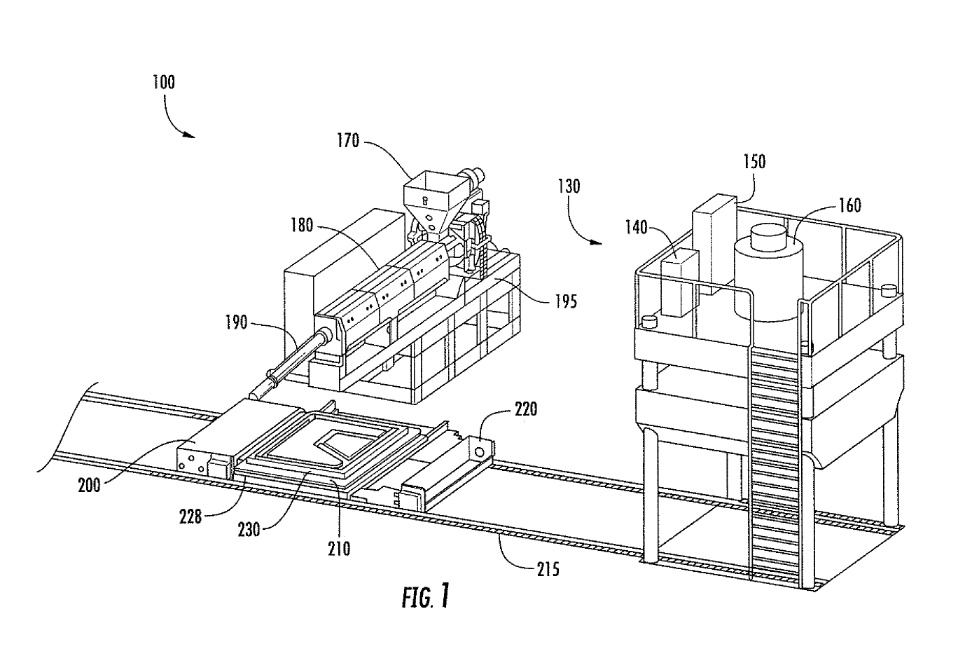

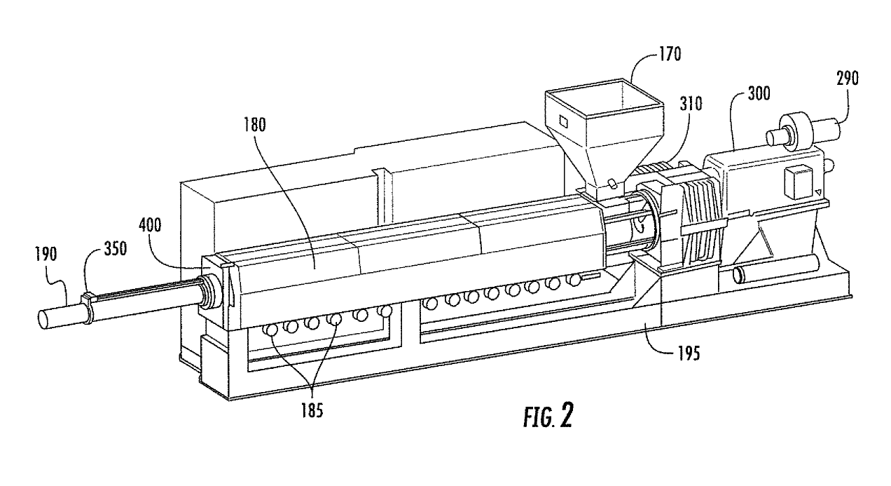

Referring initially to FIGS. 1 and 2, an embodiment of the illustrated plastic molding device 100 will now be discussed. A mold base 210 is located directly below an adjustable extension barrel 190 coupled to an extruder 180. As will be discussed in greater detail below, the adjustable extension barrel 190 is moveable between an extended position and a retracted position. The extruder 180 is supported by an injection barrel frame 195. Positioned on the mold base 210 is a lower compression mold 230 for accepting molten plastic composite material in preparation for molding.

The illustrated plastic molding device 100 includes a single press 130. However, alternate embodiments can operate with two presses. The press 130 contains an upper mold required for compression molding of the parts. The press 130 has a hydraulic ram 160 for applying compressive force as well as two control cabinets 140, 150. The lower compression mold 230 rides on a movable structure 228 that rides on a pair of spaced apart rails 215. The movable structure 228 may also be referred to as a trolley. The trolley 228 can move back and back and forth below the adjustable extension barrel 190 in an x-direction that is parallel to the rails 215. The trolley 228 is interfaced between a mold carrier device 200 and a wheel block support 220 that provide a drive mechanism for moving the trolley. The moveable structure is not limited to trolley and rail configuration. Other configurations for moving the lower mold are readily acceptable.

To achieve control of material deposition in the y-direction (perpendicular to the rails 215), the adjustable extension barrel 190 is moveable between an extended position and a retracted position. The adjustable extension barrel 190 avoids the need for a second trolley as required in the above-referenced Polk application (U.S. published patent application no. 2013/0193611). The adjustable extension barrel 190 simplifies deposition of the extruded material in the y-direction.

The combination of being able to control the x-direction with the trolley and the y-direction with the adjustable extension barrel 190 gives control of the x-y plane. When this is combined with the ability to control the volumetric flow of molten composite material emanating from the adjustable extension barrel 190, this gives in effect 3-axis control and the capability to create “near net shape” parts on the lower compression mold 230 before the upper mold is applied for compression.

A material feed hopper 170 accepts polymeric resin or composite material into an auger or screw section where heaters are heating the polymeric material to a molten state while the auger or screw 320 is feeding it along the length of the adjustable barrel 190. A screw motor 300 with a cooling fan 290 drives a hydraulic injection unit 310.

Heaters 185 along the injection barrel maintain temperature control. The molten composite material is fed from a drop point 340 of the adjustable extension barrel 190 onto the lower compression mold 230.

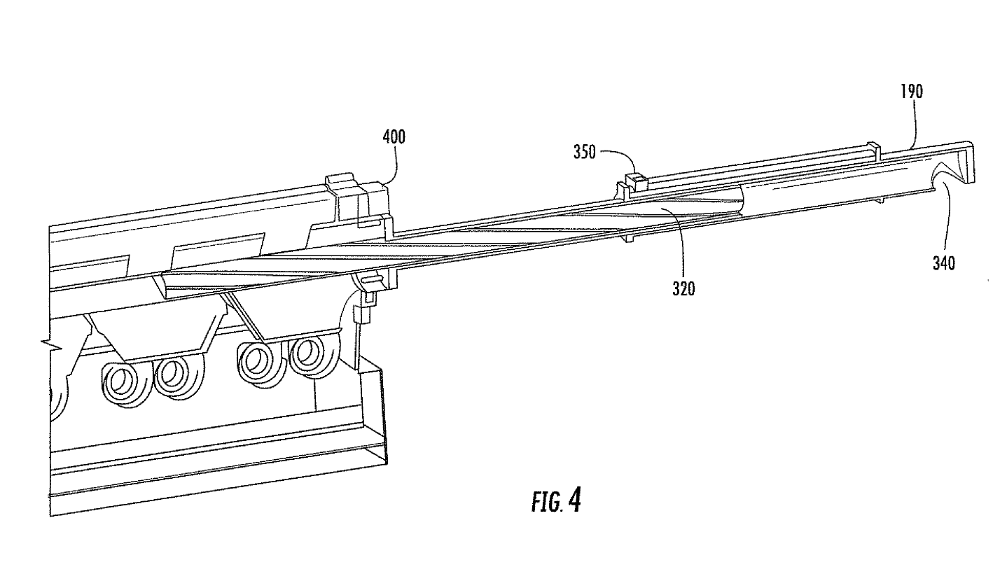

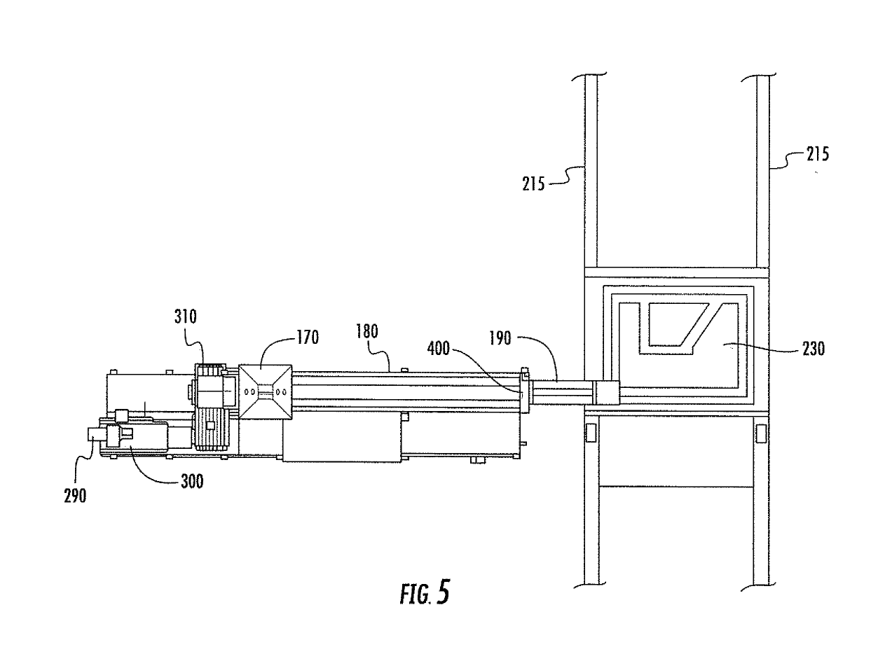

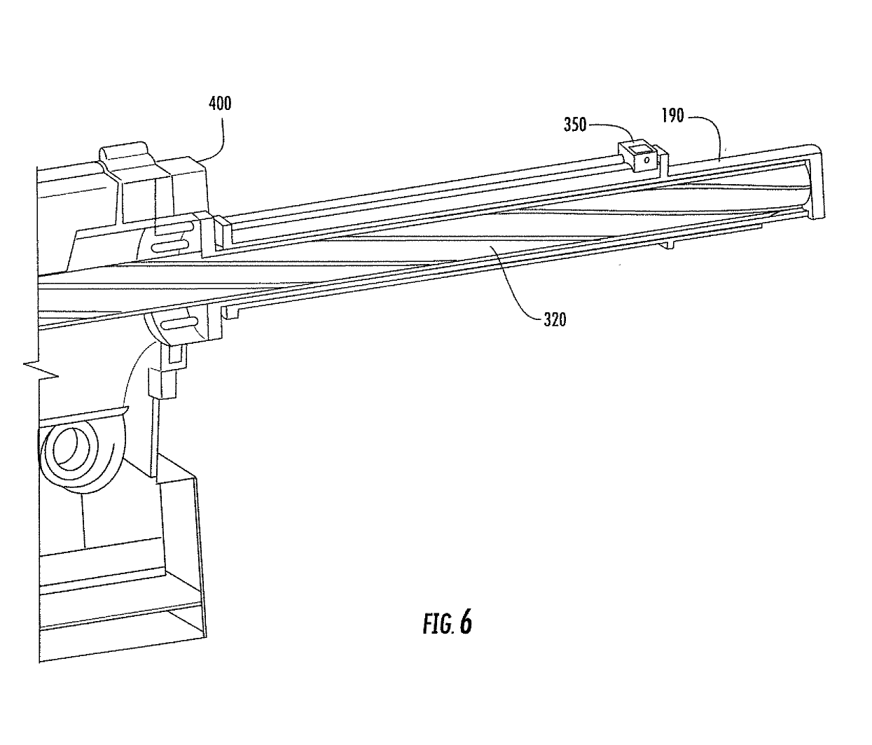

As illustrated in FIGS. 4 and 5, the adjustable extension barrel 190 is in a fully extended position. As the screw or auger 320 rotates, the molten composite material is pushed toward the drop point 340. As illustrated in FIGS. 5 and 6, the adjustable extension barrel 190 is in a fully retracted position. As the screw 320 rotates, the molten composite material exits the drop point 340.

An advantage of the adjustable extension barrel 190 in the fully retracted position is that molten composite material will not remain in the barrel since there is no gap between the screw 320 and the drop point 340. For example, if 150 pounds of material was placed in the hopper 170, then the operator will know that 150 pounds of material will exit the drop point 340, particularly when the adjustable extension barrel 190 is in the fully retracted position. For color changes in the molten composite material, this avoids an overlap of parts with different colors then as initially intended.

Actuators 350 control movement of the adjustable extension barrel 190 between the retracted and extended positions. A controller 400 controls movement of the adjustable extension barrel 190 in the y-direction. This is done in coordination with movement of the lower compression mold 230 in the x-direction.

The lower half of the matched-mold discretely moves in space and time at varying speeds and in a back and fourth movement in the x-direction. Likewise, the drop point 340 of the adjustable barrel 190 discretely moves in space and time at varying speeds and in a back and fourth movement but in the y-direction. This enables the deposit of material precisely and more thickly at slow speed and more thinly at faster speeds.

Although not illustrated, a deposition tool may be coupled to a drop point 340 for feeding the molten composite material precisely onto the lower compression mold 230. It should be noted that the deposition tool in some embodiments could be as simple as a straight pipe acting as an injection nozzle but could also be a sheet die.

The combination of x-y control of the lower compression mold 230 and the adjustable extension barrel 190 and control of the volumetric flow rate of the molten material allows precise deposition of the molten composite material into the desired location in the lower compression mold 230 so that a “near net shape” of the molded part is created. This includes sufficient molten material deposited in locations with deeper cavities in the lower mold. Upon completion of the “near net shape” molten deposition of the composite material, the filled half of the matched mold is mechanically transferred by the trolley 228 along the rails 215 to the compression press 130 for final consolidation of the molded part.

Since the filled half of the mold represents a “near net shape” of the final molded part, the final compression molding step with the other half of the matched mold can be accomplished at very low pressures (<2000 psi) and with minimal movement of the molten composite mixture.

The extrusion-molding process thus includes a computer-controlled extrusion system that integrates and automates material blending or compounding of the matrix and reinforcement components to dispense a profiled quantity of molten composite material that gravitates into the lower half of a matched-mold from the adjustable extension barrel 190, the movements of which are controlled while receiving the material. The compression molding station 130 receives the lower half of the mold 230 for pressing the upper half of the mold against the lower half to form the desired structure or part.

The lower half of the matched-mold discretely moves in space and time at varying speeds and in a back and fourth movement in the x-direction (i.e., first direction). Likewise, the drop point 340 of the adjustable barrel 190 discretely moves in space and time at varying speeds and in a back and fourth movement but in the y-direction (i.e., second direction). This enables the deposit of material precisely and more thickly at slow speed and more thinly at faster speeds.

Unprocessed resin (which may be any form of regrind or pleated thermoplastic or, optionally, a thermoset epoxy) is the matrix component fed into a feeder or hopper of the injection head, along with reinforcement fibers greater than about 12 millimeters in length. The composite material 240 may be blended and/or compounded by the adjustable barrel 190, and “intelligently” deposited onto the lower mold half 230 by controlling the output of the adjustable barrel 190 and the movement of the lower mold half 230 in the x-direction and movement of the adjustable extension barrel in the y-direction. The lower section of the matched-mold receives precise amounts of extruded composite material, and is then moved into the compression molding station.

The software and computer controllers needed to carry out this computer control encompass many known in the art. Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the illustrated embodiment may be a stand-alone application, network based, or wired or wireless Internet based to allow easy, remote access. The application may be run on a personal computer, a data input system, a PDA, cell phone or any computing mechanism.

The computer based controller 400 is electrically coupled to the various components that form the molding system or could operate in a wireless manner. The controller 400 is a processor-based unit that operates to orchestrate the forming of the structural parts. In part, the controller 400 operates to control the composite material being deposited on the lower mold by controlling temperature of the composite material, volumetric flow rate of the extruded composite material, and the positioning and rate of movement of the lower mold 230 in the x-direction and position and rate of movement of the adjustable extension barrel 190 in the y-direction to receive the extruded composite material.

The controller is further operable to control the heaters that heat the polymeric materials. The controller may control the rate of the screw 320 to maintain a substantially constant flow of composite material through the barrel to the drop point 340. Alternatively, the controller may alter the rate of the screw 320 to alter the volumetric flow rate of the composite material from the drop point 340. The controller may further control heaters in the barrel.

Based on the structural part being formed, a predetermined set of parameters may be established for applying the extruded composite material to the lower compression mold 230. The parameters may also define how the movement of the lower mold half 230 in the x-direction and movement of the adjustable extension barrel in the y-direction are positionally synchronized with the volumetric flow rate of the composite material in accordance with the cavities on the lower mold that the define the structural part being produced.

Upon completion of the extruded composite material being applied to the lower mold, the controller 400 drives the lower compression mold 230 to the press 130. The controller 400 then signals a mechanism to disengage the wheels from the track 215 so that the press 120 can force the upper mold against the lower mold without damaging the wheels.

The controller 400 may also be configured to support multiple structural parts so that the extrusion-molding system 100 may simultaneously form the different structural parts via the press 130. Because the controller 400 is capable of storing parameters operable to form multiple structural parts, the controller may simply alter control of the drop point 340 and the lower compression mold 230 by utilizing the parameters in a general software program, thereby providing for the formation of two different structural parts using a single drop point. It should be understood that additional presses and lower compression molds (i.e., trolleys) might be utilized to substantially simultaneously produce more structural parts via a single injection head.

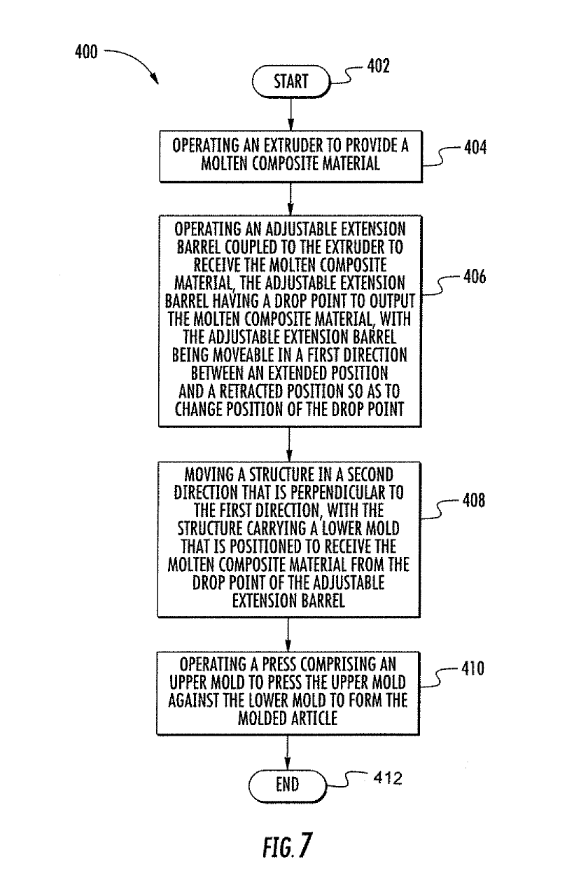

Another aspect is directed to a method of using a molding apparatus 100 to form a molded article. Referring now to the flowchart 400 illustrated in FIG. 7, from the start (Block 402), the method comprises operating an extruder 180 to provide a molten composite material at Block 404. The method further comprises at Block 406 operating an adjustable extension barrel 190 coupled to the extruder 180 to receive the molten composite material. The adjustable extension barrel 190 has a drop point 340 to output the molten composite material. The adjustable extension barrel 190 is moveable in a first direction between an extended position and a retracted position so as to change position of the drop point 340.

A structure 288 is moved in a second direction that is perpendicular to the first direction at Block 408. The structure 288 is carrying a lower mold 230 that is positioned to receive the molten composite material from the drop point 340 of the adjustable extension barrel 190. A press 130 comprises an upper mold and is operated at Block 410 to press the upper mold against the lower mold 230 to form the molded article. The method ends at Block 412.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

That which is claimed:

1. A molding apparatus comprising:
an extruder configured to provide a molten composite material;
an adjustable extension barrel coupled to said extruder to receive the molten composite material and having a drop point to output the molten composite material, with said adjustable extension barrel being moveable in a first direction between an extended position and a retracted position so as to change position of the drop point;
a structure movable in a second direction that is perpendicular to the first direction;
a lower mold carried by said structure and positioned to receive the molten composite material from the drop point of said adjustable extension barrel; and
a press comprising an upper mold and configured to press said upper mold against said lower mold to form a molded article.

2. The molding apparatus according to claim 1 wherein the extruder comprises an auger that pushes the molten composite material toward the drop point of said adjustable extension barrel; and when said adjustable extension barrel is in the retracted position, the drop point is adjacent said auger.

3. The molding apparatus according to claim 1 wherein there is no gap between said auger and the drop point when the adjustable extension barrel is in a fully retracted position.

4. The molding apparatus according to claim 1 wherein the molten composite material is gravity deposited from the drop point of said adjustable extension barrel to said lower mold.

5. The molding apparatus according to claim 1 further comprising a controller for controlling a volumetric flow of the molten composite material from the drop point of said adjustable extension barrel.

6. The molding apparatus according to claim 1 wherein said lower mold is configured to provide a near net shape of the molded part after receiving the molten composite material.

7. The molding apparatus according to claim 1 further comprising a pair of spaced apart rails; and wherein said structure comprises a trolley that rides on said pair of spaced apart rails.

8. The molding apparatus according to claim 1 wherein the molten composite material comprises a matrix component and at least one reinforcement component.

9. The molding apparatus according to claim 1 wherein the molten composite material comprises a molten plastic composite, with the molten plastic composite comprising at least one of a thermoset composite and a thermoplastic composite.

10. A plastic molding apparatus comprising:
an extruder comprising an auger configured to provide a molten plastic material;
an adjustable extension barrel configured to receive said auger and the molten plastic material, said adjustable extension barrel having a drop point to output the molten plastic material, and with said adjustable extension barrel being moveable in a first direction between an extended position and a retracted position so as to change position of the drop point;
a structure movable in a second direction that is perpendicular to the first direction;
a lower mold carried by said structure and positioned to receive the molten plastic material from the drop point of said adjustable extension barrel; and
a press comprising an upper mold and configured to press said upper mold against said lower mold to form a molded article.

11. The molding apparatus according to claim 10 wherein when said adjustable extension barrel is in the retracted position, the drop point is adjacent said auger.

12. The molding apparatus according to claim 10 wherein there is no gap between said auger and the drop point when the adjustable extension barrel is in a fully retracted position.

13. The molding apparatus according to claim 10 wherein the molten plastic material is gravity deposited from the drop point of said adjustable extension barrel to said lower mold.

14. The molding apparatus according to claim 10 further comprising a controller for controlling a volumetric flow of the molten plastic material from the drop point of said adjustable extension barrel.

15. A method of using a molding apparatus to form a molded article comprising:
operating an extruder to provide a molten composite material;
operating an adjustable extension barrel coupled to the extruder to receive the molten composite material, the adjustable extension barrel having a drop point to output the molten composite material, with the adjustable extension barrel being moveable in a first direction between an extended position and a retracted position so as to change position of the drop point;
moving a structure in a second direction that is perpendicular to the first direction, with the structure carrying a lower mold that is positioned to receive the molten composite material from the drop point of the adjustable extension barrel; and
operating a press comprising an upper mold to press the upper mold against the lower mold to form the molded article.

16. The method according to claim 15 wherein the extruder comprises an auger that pushes the molten composite material toward the drop point of the adjustable extension barrel, and when the adjustable extension barrel is moved to the retracted position, the drop point is adjacent the auger.

17. The method according to claim 15 wherein there is no gap between the auger and the drop point when the adjustable extension barrel is in a fully retracted position.

18. The method according to claim 15 wherein the molten composite material is gravity deposited from the drop point of the adjustable extension barrel to the lower mold.

19. The method according to claim 15 further comprising operating a controller for controlling a volumetric flow of the molten composite material from the drop point of the adjustable extension barrel.

20. The method according to claim 15 wherein the molten composite material comprises a molten plastic composite.
